(19) United States
(12) Patent Application Publication
(10) Pub. No.: US 2008/0002871 A1
(43) Pub. Date: Jan. 3, 2008

(54) PROCEDURE FOR DETECTING A DEVIATION IN A X-RAY SYSTEM FROM A TARGET POSITION

(76) Inventors: Konstanze Gunzert-Marx, Erlangen (DE); Uwe Towara, Erlangen (DE)

Correspondence Address: BRINKS HOFER GILSON & LIONE, P.O. BOX 10395, CHICAGO, IL, 60610, US

(21) Appl. No.: 11/750,158

(22) Filed: May 17, 2007

(30) Foreign Application Priority Data
May 23, 2006 (DE) DE102006024242.4

(51) Int. Cl. G06K 9/00

(52) U.S. Cl. 382/132

(57) ABSTRACT

A method for detecting a deviation of an X-ray system relative to a desired position is provided. Simple, fast detection of a deviation of an X-ray system relative to a desired position is done by positioning a measurement object at a defined position; with the aid of the X-ray system, a current image of the actual position of the measurement object is made; and the current image is compared with a reference image, stored in memory, of the measurement object.

This application claims the benefit of DE 10 2006 024 242.4 filed May 23, 2006, which is hereby incorporated by reference.

### BACKGROUND

The present embodiments relate to a method for detecting a deviation of an X-ray system relative to a desired position.

Medical equipment for examination and/or treatment may include a rotatable X-ray system with an X-ray emitter and a diametrically opposed X-ray detector. The X-ray system is embodied, for example, as a C-arch that can be rotated about an examination or treatment table, or as part of a rotatable gantry into which a patient supported on an examination or treatment table is moved. This kind of examination and/or treatment equipment includes least one reference point, such as a focal point or an isocenter. To assure optimal examination and/or treatment, the components of the apparatus, including the X-ray system, must accordingly be put in a defined desired position relative to this reference point.

### SUMMARY

Simple, fast detection of a deviation of an X-ray system relative to a desired position may be obtained by a method for detecting a deviation of an X-ray system relative to a desired position, in which a measurement object is positioned in a defined position; with the aid of the X-ray system, a current image of the actual position of the measurement object is made; and the current image is compared with a reference image, stored in memory, of the measurement object.

Detecting a possible deviation is possible by comparing the current image of the measurement object with its reference image. The reference image was made when the measurement object was positioned precisely in its desired position. A reference image of this kind can be taken, for example, upon initial calibration of the X-ray system. The spatial coordinates of the position of the measurement object when the reference image is made are stored in memory, so that the measurement object can later be put in precisely the same desired position at any time.

The measurement object is, for example, a simple geometrical object, such as a ball. The measurement object, for making the images, is positioned between an X-ray emitter and an X-ray detector of the X-ray system.

The location of the measurement object is correlated with the position of the X-ray system, by making the reference image and the current image using the same picture-taking parameters: the same depth of focus, aperture, exposure time, image resolution, distance from the measurement object, and spatial orientation of the X-ray system during the picture-taking. Since the positioning of the measurement object in its desired position is highly precisely replicable, a detected deviation of the actual position of the measurement object in the current image is an indication of a shift of the X-ray system relative to its desired position.

Except for the measurement object, which is a simple geometrical body, no further technical objects are necessary for performing the method. The method is economical. The method requires little time.

In one embodiment, a deviation of a focal point of an X-ray emitter from an isocenter is detected. The isocenter, which is the point where the X-ray emitters meet as the X-ray system rotates, is determined upon initial installation of the medical examination and/or treatment apparatus. The isocenter's fixed coordinates in space are stored in memory. In a subsequent examination and/or treatment of a patient, the patient's tissue to be examined or treated is positioned precisely in the isocenter, and the radiation components of the apparatus, such as the X-ray system, are focused precisely on the isocenter. The desired position of the measurement object corresponds to the isocenter. With the aid of the current image, a check is made as to whether the focal point of the X-ray system is in fact focused on the isocenter.

In another embodiment, the X-ray system includes an examination or treatment table. A deviation of the examination or treatment table from its desired position is ascertained. Since positioning the patient with respect to the examination and/or treatment apparatus is done by way of the examination or treatment table, the position of the examination or treatment table is of major significance for the successful examination/treatment of the patient. The position of the measurement object is correlated with that of the examination or treatment table, for example, by securing the measurement object to the examination or treatment table or connecting it mechanically to it in such a way that its connection is highly precisely replicable. A detected deviation in the actual position of the measurement object from its desired position, if the current image was taken by the precisely calibrated X-ray system, indicates a shift of the examination or treatment table relative to its desired position.

In one embodiment, the two images are subtracted by computer from one another. The regions that differ in the two images are displayed and evaluated. One advantage is the attainable good resolution of the images and the high precision with which the position of the measurement object is determined. The images made are not manipulated themselves. A computer-based subtraction is done, the result of which is a generated subtraction image in which only the regions that differ in the two images are displayed. Comparison by a computer of the images made requires only minimal labor and time.

In one embodiment, the evaluation is made with the aid of an image evaluation that is used for a digital subtraction analysis. A conventional software implementation of the subtraction method can be employed, such as a software program for evaluating digital subtraction angiography. There is no need to develop novel software for the subtraction analysis. Recourse can be had to an often already-integrated software component in existing systems.

In one embodiment, a spacing calibration is associated with the reference image. The deviation in the current image from the desired position is measured on the reference image. A measurement ruler on a suitable scale is provided on the reference image, and with the aid of this ruler the shift in the measurement object relative to its desired position is measured, for example, on the micrometer order of magnitude. Besides detecting a deviation of the X-ray system from the desired position, a measurement of the magnitude of this deviation is also possible, to facilitate a subsequent correction in the position of the X-ray system and perform it as precisely as possible. A threshold value is defined. The threshold is adjustable as a function of the picture-taking parameters, such as the resolution of the images. If the deviation of the measurement object is below the threshold value, the X-ray system is adequately precisely set. If the deviation is above the threshold value, then repositioning of the X-ray system is necessary.

In another embodiment, the method includes recalibration of the X-ray system upon a deviation of the measurement object from its desired position, as a function of this deviation. A deviation of the measurement object that indicates a shift in the X-ray system has been found, the X-ray system is moved to its desired position, so as to attain optimal results in the examination/treatment of the patient.

Once the X-ray system has been recalibrated, a further current image is made. The further current image is compared with the reference image. In this comparison, a check is made as to whether the X-ray system was in fact moved to its desired position, so that any shifting which could impair the examination/treatment of the patient is precluded.

In one embodiment, a plurality of reference images from a plurality of directions, in particular from three directions parallel to the axes of a cartesian coordinate system, are stored in memory. The actual position of the measurement object from the plurality of directions is recorded. Alternatively, a cone beam computed tomograph system may be used. Rotation of the computed tomograph furnishes a 3D data set pertaining to the position of the measurement object. The evaluation of the exact position of the X-ray system is done from a plurality of angles, so that the position of the measurement object is detected two- or three-dimensionally.

### BRIEF DESCRIPTION OF THE DRAWINGS

FIG. 1 is a side view of an X-ray system with a patient supported on an examination or treatment table;

FIG. 2 is a side view of the X-ray system of FIG. 1 with a measurement object;

FIG. 3a illustrates a reference image of a measurement object;

FIG. 3b illustrates a current image of the measurement object of FIG. 2a; and

FIG. 3c illustrates a subtraction image of the measurement object of FIGS. 3a and 3b.

### DETAILED DESCRIPTION

Throughout the drawings, the same reference numerals have the same meaning.

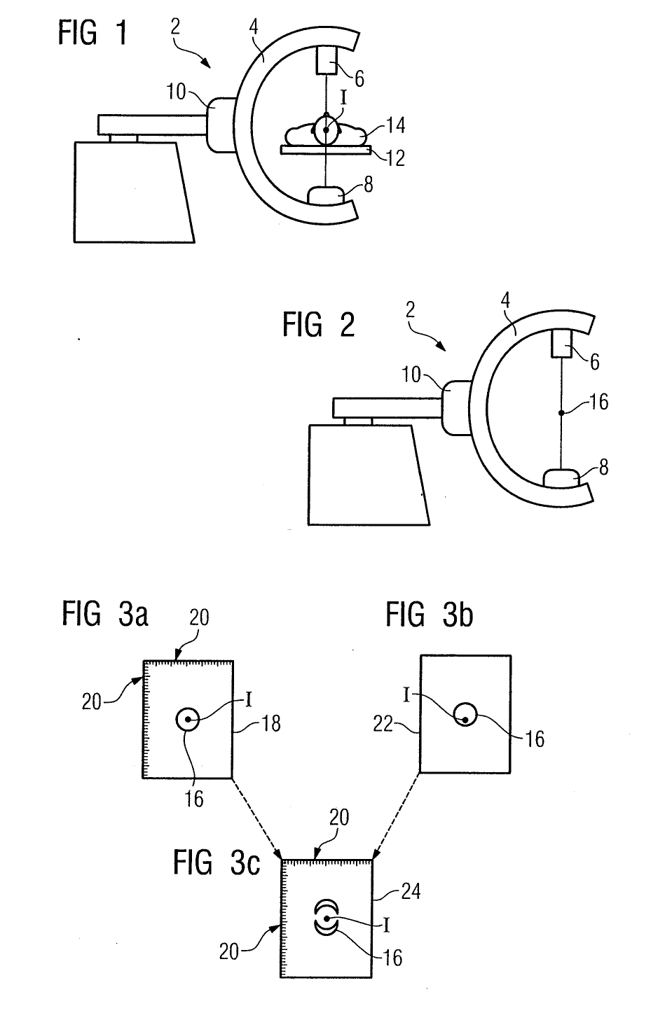

In one embodiment, as shown in FIG. 1, an X-ray system 2 is embodied as a C arch. Alternatively, the X-ray system may be part of a rotatable gantry. The X-ray system 2 has a curved arm 4 for carrying both an X-ray emitter 6 and an X-ray detector 8, which are diametrically opposite one another. The arm 4 is supported by a mount 10. The X-ray emitter 6 includes a built-in X-radiation tube and emits X-rays in the direction of the X-ray detector 8. The X-ray detector 8 has a built-in image amplifier and detects the X-rays that are emitted by the X-ray emitter 6.

The X-ray system 2 includes an isocenter I, which is located in a space between the X-ray emitter 6 and the X-ray detector 8. The isocenter I corresponds to a center point of the arm 4 and is fixed. A rotation mechanism is mounted in the mount 10 and moves the arm 4 along a curve. The X-ray emitter 6 and the X-ray detector 8 rotate about the isocenter I.

An examination or treatment table 12, on which a patient 14 lies on his back, is positioned between the X-ray emitter 6 and an X-ray detector 8. During operation of the X-ray system 2, the examination or treatment table 12 is positioned in such a way that the tissue to be irradiated of the patient 14 is located precisely in the isocenter I. During operation of the X-ray system 2, the X-rays emitted by the X-ray emitter 6 are also focused on the isocenter I and thus on the tissue to be irradiated of the patient 14.

As shown in FIG. 2, the X-ray system 2 includes a measurement object 16. The measurement object 16 can be used to check whether a deviation of the X-ray system 2 from the isocenter I exists. In this exemplary embodiment, the measurement object 16 takes the form of a metal ball of a defined diameter, which is positioned in the isocenter I in order to visualize it.

Upon an initial calibration of the X-ray system 2, the isocenter I is determined, and its space coordinates are stored in memory. The measurement object 16 is then positioned in the isocenter I, and the X-ray system 2 makes a reference image 18 (see FIG. 3a) of the measurement object 16. This reference image 18 is stored in the memory of a control unit of the X-ray system 2. The reference image 18 is provided with a spacing calibration 20, which includes two vertical linear measurement rulers on two adjacent sides of the reference image 18. The desired position of the measurement object 16 is indicated to micrometer precision.

At a later time, a further image of the measurement object 16 is made. The measurement object 16 is positioned at the isocenter I once again. It is now checked whether the actual position of the measurement object 16 matches the isocenter I (that is, the desired position of the measurement object 16), or in other words whether a deviation in the position of the X-ray system 2 relative to the isocenter I exists. A current image 22 of the measurement object 16, shown in FIG. 3b, is recorded with precisely the same parameters as the reference image 18. These parameters are, for example, the depth of focus, the aperture, the exposure time, the image resolution, the distance of the X-ray emitter 6 and the X-ray detector 8 from the measurement object 16, and the spatial orientation of the X-ray system 2 during the picture-taking.

A software program can detect a deviation of the measurement object 16 in the current image 22 from its desired position shown in the reference image 18. This software program is preferably a conventional image processing program that operates on the subtraction principle. In this exemplary embodiment, it is a software program for evaluating digital subtraction angiography. The current image 22 is subtracted by computer from the reference image 18, so that only the regions that are different in the two images are displayed.

Each pixel of the digital images 18, 22 of the measurement object 16 are assigned a gray value. Upon the subtraction of the images 18, 22, the gray values of the individual pixels of both images 18, 22 are compared with one another. If the gray values differ, and a threshold, in particular an adjustable threshold, has been exceeded, then the corresponding pixels are displayed in a subtraction image 24, which is shown in FIG. 3c. Only the regions of the two images 18, 22 made that differ from one another are displayed in the subtraction image 24. An existing deviation of the measurement object 16 from the isocenter I is shown in the subtraction image 24. The deviation is measured to micrometer precision using the measuring ruler 20.

Since the positioning of the measurement object 16 in the isocenter I for making the current image 22 is highly precise, a deviation detected in the subtraction image 24 of its actual position from its desired position indicates a shift in the X-ray system 2 relative to the isocenter I. Depending on the measured deviation, the X-ray system 2 in this exemplary embodiment is recalibrated. Next, further current images 22 may be taken, and the measurement and recalibration process can be repeated, until no deviation in the subtraction image 24 is visible any longer, or until the deviation is below a threshold value. Since performing this method requires little time, it can be employed in particular for measuring the daily deviation.

In FIGS. 3a and 3b, only a single reference image 18 is shown, which was taken from a direction from which the current image 22 was also made. Images can be made from a plurality of directions, in particular from three directions, which are parallel to the axes of a cartesian coordinate system. For each imaging direction, a separate reference image 18 is made, which is compared with current images 22 from the same imaging directions.

The method has been described as an example for detecting a deviation of the X-ray system 2 relative to the isocenter I. This method can be employed also for detecting a deviation of the examination or treatment table 12 with respect to the isocenter I. The measurement object 16 is preferably secured to the examination or treatment table 12 or is connected replicably to the examination or treatment table 12.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for detecting a deviation of an X-ray system relative to a desired position, wherein a measurement object is positioned in a defined position, the method comprising:
making a current image of an actual position of the measurement object; and
comparing the current image with a reference image, which is stored in memory, of the measurement object.

2. The method as defined by claim 1, comprising: detecting a deviation of a focal point of an X-ray emitter from an isocenter.

3. The method as defined by claim 1, wherein the X-ray system includes an examination or treatment table, the method comprising: ascertaining a deviation of the examination or treatment table from its desired position.

4. The method as defined by claim 1, comprising: subtracting the current image and the reference image by computer, and
displaying and evaluating regions that differ in the current image and the reference image.

5. The method as defined by claim 4, wherein evaluating the regions that differ includes using an image evaluation that is used for a digital subtraction analysis.

6. The method as defined by claim 2, wherein a spacing calibration is associated with the reference image, the method comprising: measuring the deviation in the current image from the desired position on the reference image.

7. The method as defined by claim 1, comprising: recalibrating the X-ray system as a function of the deviation when the measurement object deviates from its desired position.

8. The method as defined by claim 7, comprising: making a further current image, which is compared with the reference image.

9. The method as defined by claim 1, comprising: storing a plurality of reference images from a plurality of directions in memory, and recording the actual position of the measurement object from the plurality of directions.

10. The method as defined by claim 9, wherein the plurality of directions, includes three directions parallel to the axes of a cartesian coordinate system.

11. The method as defined by claim 2, wherein the X-ray system includes an examination or treatment table, the method comprising: ascertaining a deviation of the examination or treatment table from its desired position.
